(19) United States
(12) Patent Application Publication
(10) Pub. No.: US 2010/0141908 A1
(43) Pub. Date: Jun. 10, 2010

(54) PROJECTING DEVICE

(75) Inventors: Tatsuo Uchida, Miyagi (JP); Tetsuya Abe, Tokyo (JP); Ken Agatsuma, Tokyo (JP)

Correspondence Address: GREENBLUM & BERNSTEIN, P.L.C., 1950 ROLAND CLARKE PLACE, RESTON, VA, 20191, US

(73) Assignees: TOHOKU UNIVERSITY, Miyagi (JP); HOYA CORPORATION, Tokyo (JP)

(21) Appl. No.: 12/525,572

(22) PCT Filed: Jan. 31, 2008
(86) PCT No.: PCT/JP2008/051539

§ 371 Date: Jan. 4, 2010

(30) Foreign Application Priority Data
Feb. 1, 2007 (JP) 2007-022743

(51) Int. Cl. G03B 21/28; G02B 27/18

(52) U.S. Cl. 353/99

(57) ABSTRACT

A rear-projection type projecting device enlarging and projecting an image displayed by a display device onto a screen, including a projecting optical system including a first optical system having a positive power and a second optical system having a reflection surface with a positive power, and a plane mirror attached to the projecting device to form a substantially right angle with respect to the screen and to reflect light emerging from the projecting optical system to the screen, wherein an effective reflection area of the reflection surface with the positive power is located at a position farther from an optical axis of the first optical system when viewed from the plane mirror.

### TECHNICAL FIELD

The present invention relates to a projecting device that projects a display image formed by a display device.

### BACKGROUND OF THE INVENTION

Projecting devices configured to project a display image formed by a display device have been widely used. For example, the projecting device is configured to be a so-called rear projector which projects a display image on a back side of a screen so as to enable a user to observe the display image from the front side of the screen. A projecting device of this type is disclosed, for example, in Japanese Patent Provisional Publications No. 2004-258620A (hereafter, referred to as document #1) and No. 2002-207190A (hereafter, referred to as document #2).

The projecting device disclosed in document #1 uses a projecting optical system having a concave mirror. By using the concave mirror, the projecting device disclosed in document #1 secures a relatively wide angle of view while suppressing chromatic aberration of magnification. Therefore, a thin projecting device can be provided.

To further thin the projecting device disclosed in document #1, it becomes necessary to locate a plane mirror on a rear side of the projecting device (i.e., on a surface facing the back side of the screen) to project the image on the screen using the plane mirror. That is, in the projecting device disclosed document #1, almost all of space between the back side of the screen and the plane mirror needs to be secured for an optical path. Therefore, a projecting optical system needs to be located outside the screen when viewed from the front side of the screen. Accordingly, the configuration disclosed in document #1 is not able to match the length of the projecting device in the vertical direction (i.e., the height of the projecting device) to the length of the screen in the vertical direction (i.e., the height of the screen). That is, the configuration disclosed in document #1 is not able to achieve a so-called frameless shape.

In this specification, a state where a projecting device is placed such that the screen is positioned vertically is referred to as a “normal use state”. In the normal use state, the surface on which the screen is located is defined as a front surface, a surface opposite to the front surface is defined as a rear surface, a surface opposite to a bottom surface (i.e., a mounting surface on which the projecting device is placed) is defined as a top surface. Each of the top surface and the bottom surface is perpendicular to the screen. In a cross section of the projecting device formed by a plane perpendicular to the top surface or the bottom surface in the normal use state, a direction proceeding from the rear surface to the front surface is defined as a frontward direction, a direction proceeding from the front surface toward the rear surface is defined as a backward direction, a direction proceeding from the bottom surface to the top surface is defined as an upward direction, and a direction proceeding from the top surface to the bottom surface is defined as a downward direction.

In contrast to the configuration disclosed in document #1, the projecting device disclosed in document #2 is configured to locate a plane mirror on the top surface (i.e., a top plate) of the device. Further, in the projecting device, a convex mirror is located to reflect upward light from a light source toward the top plate. Since the plane mirror turns the direction of the incident light toward the front and downward side of the device, an image is projected on the screen. In this configuration, an optical path of light proceeding from the projecting optical system to the screen via the plane mirror is different from the optical path in the configuration disclosed in document 1. Therefore, it becomes possible to secure space, in which no optical path is located, between the back side of the screen and the rear surface of the device. Furthermore, the projecting device disclosed in document #2 achieves a frameless shape by locating the projecting optical system in the space.

As described above, the projecting device disclosed in document #2 uses the convex mirror. In this case, the convex mirror is required to enlarge further an image which has been enlarged by optical components on the front side of the convex mirror, and to direct the image to the plane mirror. Therefore, the size of the convex mirror inevitably increases. Nevertheless, according to the optical arrangement of the projecting device of document #2, the convex mirror needs to be located closer to the plane mirror than other optical components located on the front side of the convex mirror. That is, according to the projecting device disclosed in document #2, it is necessary to locate a relatively large optical component (i.e., the convex mirror) at a position closer to the plane mirror regardless of the fact that the above described space in which no optical path is located becomes larger at a position further from the plane mirror. Therefore, the projecting optical system can not be arranged effectively. In other words, drawbacks that the degree of freedom for design deteriorates and thereby the size of the device increases inevitably arise.

### DISCLOSURE OF THE INVENTION

### Problem to be Solved

In consideration of the above described problem, the object of the present invention is to provide a rear-projection type projecting device configured to achieve a frameless shape while thinning the entire shape of the device by enhancing the degree of effectiveness of arrangement of optical components forming an projecting optical system.

### Means for Solving Problem

To solve the above described problem, according to an aspect of the invention, there is provided a rear-projection type projecting device enlarging and projecting an image displayed by a display device onto a screen, which includes a projecting optical system including a first optical system having a positive power and a second optical system having a reflection surface with a positive power, and a plane mirror attached to the projecting device to form a substantially right angle with respect to the screen and to reflect light emerging from the projecting optical system to the screen. An effective reflection area of the reflection surface with the positive power is located at a position farther than a position of an optical axis of the first optical system when viewed from the plane mirror.

According to the above described projecting device of the present invention, the projecting optical system employs the reflection surface with the positive power, and the components are arranged as described above to provide the projecting device with the frameless shape. Further, in the projecting device, the effective area of the reflection surface is located on a lower side with respect to another component forming the projecting optical system, i.e., the optical axis of the first optical system. That is, the reflection surface which is required to have a relatively large size in the components forming the projecting optical system is located at a lower portion where the possibility of interfering with an optical path does not arise. With this configuration, the degree of freedom of design can be enhanced, and therefore a thin projecting device can be provided.

The display device may be located at a position closer to the plane mirror relative to the optical axis of the first optical system in a plane perpendicular to the optical axis of the first optical system, and the first optical system may form an intermediate image on a front side of the second optical system.

When, in a cross section formed by a plane which includes a hypothetical line extending vertically to pass through a center of the screen and which is perpendicular to the screen, HL represents a distance between the optical axis of the first optical system and an end of the screen on a side of the plane mirror, and VS represent a length of the screen in a vertical direction, the projecting device may satisfy a following condition:

0.5<HL/VS<0.9

When, in a cross section formed by a plane which includes a hypothetical line extending vertically to pass through a center of the screen and which is perpendicular to the screen, HM represents a sum of a distance between the optical axis of the first optical system and an end of the screen on a side of the plane mirror and a distance between the optical axis of the first optical system and a lowermost end of the effective reflection area of the second optical system L2, and VS represent a length of the screen in a vertical direction, the projecting optical system may satisfy a following condition:

0.7<HM/VS<1.0

In a cross section formed by a plane which includes a hypothetical line extending vertically to pass through a center of the screen and which is perpendicular to the screen, the projecting optical system may satisfy a condition:

0.5<θL/θu<0.85

where θu (unit: degree) represents a maximum incident angle of a light ray incident on the screen, and θL (unit: degree) represents a minimum incident angle of a light ray incident on the screen.

The projecting optical system may be configured to satisfy a condition:

75<|θM|<86

where θM represents an angle formed by a normal to the plane mirror and a normal to the screen.

In the projecting device, the display device may be located to be substantially perpendicular to the screen, and the optical axis of the first optical system from the display device to at least a part of the first optical system may be substantially parallel with the screen and is located to extend in a substantially horizontal direction. In this case, the projecting optical system may further include a deflection unit which deflects a light beam emerging from the at least a part of the first optical system toward the second optical system.

### BRIEF DESCRIPTION OF THE DRAWINGS

FIG. 1 is a cross section of a projecting device according to an embodiment of the invention, formed in a plane which includes a hypothetical line vertically extending while passing through the center of a screen and which is perpendicular to the screen.

FIG. 2 is a cross section of the projecting device according to the embodiment of the invention in a Y-Z plane.

FIG. 3(A) is a diagram developing an optical path between optical systems, and FIG. 3(B) is an enlarged view of a region P around the top end of the screen shown in FIG. 3(A).

### BEST MODE FOR CARRYING OUT THE INVENTION

In the following, an embodiment of a projecting device according to the invention is explained. In the following, for explanations of the projecting device and an optical system provided in the projecting device, a thickness direction of a screen is defined as X direction, a vertical direction is defined as Y direction and a horizontal direction (width direction) is defined as Z direction.

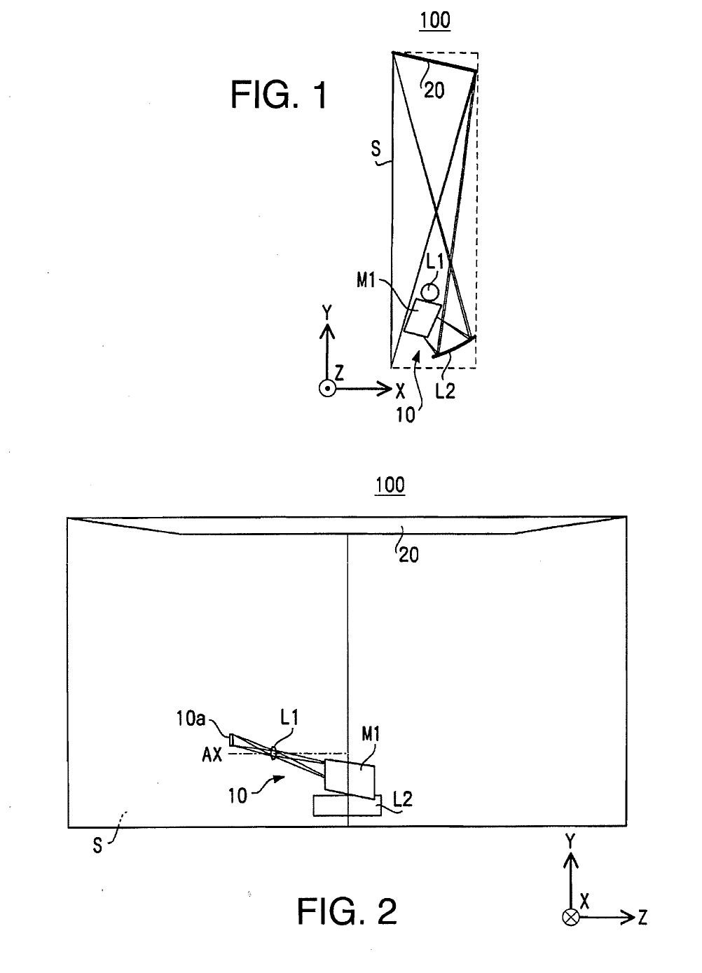

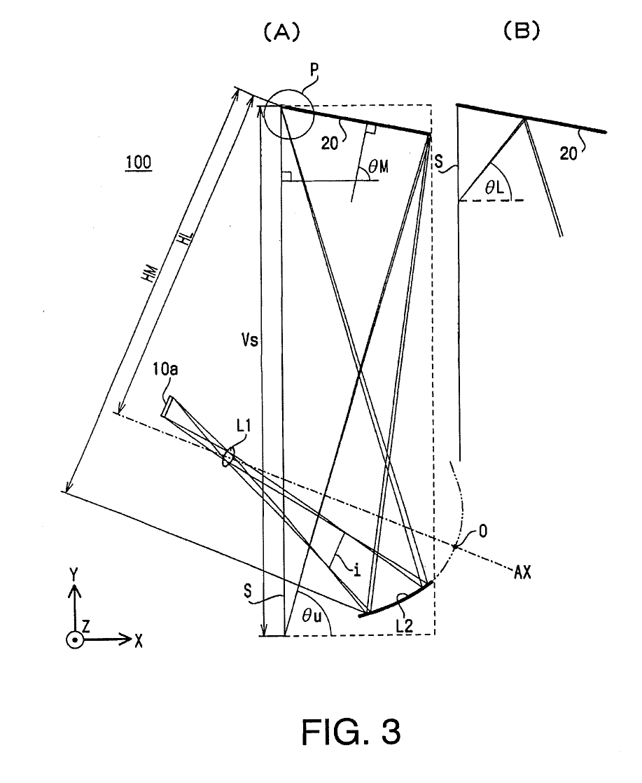

Each of FIGS. 1 and 2 is a cross section illustrating a general configuration of a projecting device 100 according to the embodiment in the normal use state. FIG. 1 is a cross section formed in a plane which includes a hypothetical line extending vertically while passing through the center of a screen S provided on the front surface of the projecting device 100 and which is perpendicular to the screen S. FIG. 2 is a cross section in a Y-Z plane formed by observing the screen S from the rear side. It should be noted that a dashed line in FIG. 1 indicates an outer shape (i.e., a housing) of the projecting device 100, ditto for FIG. 3(A) which is explained later.

The projecting device 100 includes a projecting optical system 10 and a plane mirror 20 as well as the screen S. The projection optical system 10 includes a display device 10a which is configured to have a rectangular display area and to display an image on the display area. The projecting optical system 10 includes a first optical system L1, a mirror M1 and a second optical system L2 in this order from the display device 10a along an optical path.

The first optical system L1 according to the embodiment has a positive total power, and is arranged such that an optical axis AX thereof is substantially parallel to Z direction. It should be noted that, in each of FIGS. 1 and 2, the first optical system L1 is illustrated as being formed of a single positive lens for the sake of simplicity. However, practically, the first optical system L1 may be formed of a plurality of lenses. In this embodiment, at least a part of lenses forming the first optical system L1 may be decentered for correction of aberrations and distortion. For this reason, the optical axis AX is defined as an axis which includes cores of optical surfaces most. As shown in FIG. 2, the display device 10a is located to be shifted from the optical axis AX of the first optical system L1. More specifically, the display device 10a is positioned to be shifted upward parallel to itself with respect to the optical axis AX. With this configuration, it becomes possible to project an image obliquely on the screen.

The first optical system L1 directs a light beam which has emitted from a light source (not shown) and has passed through the display device 10; toward the mirror M1. As shown in FIGS. 1 and 2, the mirror M1 is a plane mirror, and deflects the light beam emerging from the first optical system L1 to the second optical system L2. Depending on the arrangement of the first optical system L1, the mirror M1 may be located in the first optical system L1.

The second optical system L2 is formed of a single concave mirror. The second optical system L2 is located at the undermost position of all of the components of the projecting device 100 so that the light beam from the first optical system L1 is incident on the second optical system L2. More specifically, in the projecting device 100, an effective area of the concave mirror forming the second optical system L2 is located at a position lower than the optical axis AX of the first optical system L1.

The second optical system L2 deflects the light beam which is incident thereon through the mirror M1, toward the plane mirror 20 provided on the top plate. The light beam reflected from the plane mirror 20 projects an image on the back side of the screen S. A Fresnel lens (not shown) is adhered to the screen S. Therefore, the light beam obliquely incident on the Fresnel lens exits from the front side (facing the user) of the screen S perpendicularly with respect to the front side of the screen S.

Hereafter, the optical arrangement of the components including the projecting optical system 10 in the projecting device 100 is explained with reference to FIGS. 3(A) and 3(B). FIGS. 3(A) and 3(B) are explanatory illustrations for explaining the optical arrangement of the components in the projecting device 100. FIG. 3(A) is a developed view of deflection by the mirror M1 in a cross section formed by a plane which includes a hypothetical line extending vertically while passing through the center of the screen S and is perpendicular to the screen S. FIG. 3(B) is an enlarged view of a region P around the top edge of the screen S.

As shown by a double-chain line in FIGS. 3(A) and 3(B), the second optical system L2 according to the embodiment is formed to be a rotationally-symmetrical concave mirror. In the developed state of deflection by the mirror M1, the first optical system L1 and the second optical system L2 are arranged such that the rotation center O of the concave mirror is positioned on the optical axis AX of the first optical system L1.

The first optical system L1 is designed such that the light beam emitted from the first optical system L1 forms an intermediate image i between the first optical system L1 and the second optical system L2. As described above, the display device 10a is located to be upwardly shifted parallel to itself with respect to the optical axis AX. Therefore, the intermediate image is formed at the position lower than the optical axis AX. As a result, the second optical system L2 formed as the effective area of the concave mirror is also located at the position lower than the optical axis AX.

The arrangement of the optical systems L1 and L2 are achieved by satisfying the following conditions (1) and (2):

0.5<HL/VS<0.9 (1)

0.7<HM/VS<1.0 (2)

where HL represents a distance between the optical axis AX of the first optical system L1 and the tope end of the screen S (i.e., a plane mirror 20 side end of the screen S) in the cross section formed by the plane which includes a hypothetical line extending vertically (in Y direction) while passing through the center of the screen S and which is perpendicular the screen S, VS represents the length of the screen S in the vertical direction in the above described cross section, and HM represents a sum of HL and a distance between the optical axis AX and the lower end of the effective area (i.e., an effective reflection area of the concave mirror in this embodiment) of the second optical system L2 in the above described cross section.

Each of the conditions (1) and (2) is a condition to suppress the shift amount of the display device 10a from the optical axis AX while maintaining the wide angle of view and to suppress the size of an image circle of the projecting optical system 10, by appropriately setting the distance between the optical axis AX of the first optical system L1 and the top end of the screen S or the distance between the second optical system L2 and the top end of the screen S. By decreasing the size of the image circle of the projecting optical system 10, it becomes possible to decrease the size and the thickness of the projecting optical system 10, and to enhance the degree of freedom of arrangement of the projecting optical system 10 in the projecting device 100. Consequently, the frameless shape can be realized.

If the intermediate term of the condition (1) gets larger than or equal to the upper limit of the condition (1), the shift amount of the display device 10a from the optical axis AX becomes too large. Therefore, in this case, the required size of the image circle required for the projecting optical system 10 inevitably increases. As a result, the entire size of the projecting optical system 10 increases, which is undesirable. If the intermediate term of the condition (1) gets lower than or equal to the lower limit of the condition (1), it becomes impossible to secure an adequate distance between the projecting optical system 10 and the plane mirror 20. As a result, the projecting optical system 10 invades into the optical path of the light beam reflected by the plane mirror 20, which is undesirable.

If the intermediate term of the condition (2) gets larger than or equal to the upper limit of the condition (2), the second optical system L2 protrudes downward with respect to the screen S in Y direction. That is, in this case, it becomes impossible to accommodate the second optical system L2 in the housing designed to fit the size of the screen S. In other words, the frameless shape can not be realized, which is undesirable. If the intermediate term of the condition (2) gets lower than or equal to the lower limit of the condition (2), the projecting optical system 10 invades into the optical oath of the light beam reflected by the plan mirror 20, which is undesirably.

In order to achieve the frameless shape, the projecting device 100 according to the embodiment is configured to satisfy the following condition (3):

0.5<θL/θu<0.85 (3)

where θu represents the maximum incident angle (unit: degree for all of the angles defined in this embodiment) of a light ray incident on the screen S, and θL represents the minimum incident angle of a light ray incident on the screen S.

If the intermediate term of the condition (3) gets larger than or equal to the upper limit of the condition (3), the distance between the second optical system L2 and the plane mirror 20 becomes too large. Therefore, in this case, it becomes impossible to accommodate the second optical system L2 in the housing designed to fit the size of the screen S. That is, in this case, the frameless shape can not be achieved, which is undesirable. If the intermediate term of the condition (3) gets lower than or equal to the lower limit of the condition (3), it becomes impossible to secure the adequate distance between the second optical system L2 and the plane mirror 20. Therefore, in this case, the projecting optical system 10 invades into the optical path of the light beam reflected by the plane mirror 20, which is undesirable.

In order to configure the projecting device 100 to satisfy the above described conditions more easily, the plane mirror 20 is attached to the top plate such that the reflection surface of the plane mirror 20 forms a predetermined acute angle with respect to the back side of the screen S. More specifically, the plane mirror 20 is located to satisfy the following condition (4):

75<|M|<86 (4)

where θM represents an angle formed by the normal to the plane mirror 20 and the normal to the screen S. By locating the plane mirror 20 to satisfy the condition (4), positions of the components in the projecting device having the frameless shape can be optimized.

If the intermediate term of the condition (4) gets larger than or equal to the upper limit of the condition (4), the arranged position of the second optical system L2 becomes too far from screen S in X direction, and therefore the thinning of the projecting device 100 is hampered, which is undesirable. If the intermediate term of the condition (4) gets lower than or equal to the lower limit of the condition (4), the arranged position of the second optical system L2 becomes too close to the screen S in X direction, and therefore the projecting optical system 10 invades into the optical path of the light beam reflected by the reflection mirror 20, which is undesirable.

Hereafter, a concrete example of the projecting device 100 according to the embodiment will be described. Table 1 shows a concrete numerical configuration of the projecting device 100 according to the example. Table 2 shows values regarding the condition (1) to (4) of the example.

TABLE 1

| | |
|---|---|
| HL | 502.0 |
| VS | 772.0 |
| θL | 51.01 |
| θu | 74.14 |
| HM | 641.0 |
| θ | 78.5 |

TABLE 2

| | |
|---|---|
| CONDITION (1) | 0.650 |
| CONDITION (2) | 0.830 |
| CONDITION (3) | 0.688 |
| CONDITION (4) | 78.5 |

As shown in the Tables, the projecting device 100 according to the example satisfies all of the conditions (1) to (4). That is, the projecting device enhances the effectiveness concerning arrangement of each component forming the projecting optical system and thins the entire form of the device while achieving the frameless shape.

1. A rear-projection type projecting device enlarging and projecting an image displayed by a display device onto a screen, comprising:
a projecting optical system including a first optical system having a positive power and a second optical system having a reflection surface with a positive power; and
a plane mirror attached to the projecting device to form a substantially right angle with respect to the screen and to reflect light emerging from the projecting optical system to the screen,
wherein an effective reflection area of the reflection surface with the positive power is located at a position farther than a position of an optical axis of the first optical system when viewed from the plane mirror.

2. The projecting device according to claim 1,
wherein:
the display device is located at a position closer to the plane mirror relative to the optical axis of the first optical system in a plane perpendicular to the optical axis of the first optical system; and
the first optical system forms an intermediate image on a front side of the second optical system.

3. The projecting device according to claim 1,
wherein when, in a cross section formed by a plane which includes a hypothetical line extending vertically to pass through a center of the screen and which is perpendicular to the screen, HL represents a distance between the optical axis of the first optical system and an end of the screen on a side of the plane mirror, and VS represent a length of the screen in a vertical direction, the projecting device satisfies a following condition:
0.5<HL/VS<0.9

4. The projecting device according to claim 1,
wherein when, in a cross section formed by a plane which includes a hypothetical line extending vertically to pass through a center of the screen and which is perpendicular to the screen, HM represents a sum of a distance between the optical axis of the first optical system and an end of the screen on a side of the plane mirror and a distance between the optical axis of the first optical system and a lowermost end of the effective reflection area of the second optical system L2, and VS represent a length of the screen in a vertical direction, the projecting device satisfies a following condition:
0.7<HM/VS<1.0

5. The projecting device according to claim 1,
wherein, in a cross section formed by a plane which includes a hypothetical line extending vertically to pass through a center of the screen and which is perpendicular to the screen, the projecting device satisfies a condition:
0.5<θL/θu<0.85
where θu (unit: degree) represents a maximum incident angle of a light ray incident on the screen, and θL (unit: degree) represents a minimum incident angle of a light ray incident on the screen.

6. The projecting device according to claim 1,
wherein the projecting device satisfies a condition:
75<|θM|<86
where θM represents an angle formed by a normal to the plane mirror and a normal to the screen.

7. The projecting device according to claim 1,
wherein:
the display device is located to be substantially perpendicular to the screen;
the optical axis of the first optical system from the display device to at least a part of the first optical system is substantially parallel with the screen and is located to extend in a substantially horizontal direction; and
the projecting optical system further includes a deflection unit which deflects a light beam emerging from the at least a part of the first optical system toward the second optical system.
